(19) United States
(12) Patent Application Publication
(10) Pub. No.: US 2008/0007123 A1
(43) Pub. Date: Jan. 10, 2008

(54) Signal Transmission System

(76) Inventors: Dieter Klostermeier, Villingen-Schwenningen (DE); Peter Wolf, Niedereschach (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/574,765

(22) PCT Filed: Aug. 5, 2005
(86) PCT No.: PCT/EP05/53865

§ 371 Date: Mar. 6, 2007

(30) Foreign Application Priority Data
Sep. 6, 2004 (DE) 10 2004 043 053.5

(51) Int. Cl. G06F 13/40

(52) U.S. Cl. 307/135

(57) ABSTRACT

In a system with subscribers (T1, T2) of a signal transmission having different interface physics, an additional control line is disadvantageously required between these interfaces. This problem is overcome by providing between the interfaces a circuit (C) for connecting bidirectional interfaces of subscribers to unidirectional interfaces of other subscribers (T1, T2). The circuit (C) is especially advantageous in that it automatically recognizes the origin of signals.

### CROSS-REFERENCE TO RELATED APPLICATIONS

This application is a U.S. national stage application of International Application No. PCT/EP2005/053865 filed Aug. 5, 2005, which designates the United States of America, and claims priority to German application number DE 10 2004 043 053.5 filed Sept. 6, 2004, the contents of which are hereby incorporated by reference in their entirety.

### TECHNICAL FIELD

The invention relates to an arrangement comprising subscribers to a signal transmission system and a circuit for connecting bidirectional interfaces of subscribers to unidirectional interfaces of other subscribers.

### BACKGROUND

A frequent problem in transmitting signals occurs if a bidirectional transmission/reception line of an asynchronous interface is to be connected to another transmission/reception line. A favored solution which is used here but is costly is for microcontrollers of the two participating parties to a communication to use an additional control line to agree the driver direction between transmission and reception with one another in the sense of a transmission/reception protocol. The decisive disadvantage of this procedure is the need for an additional control line between the first and second subscribers, for example between a sensor for determining a measured value which is correlated to a velocity and a tachograph for recording the velocity of a utility vehicle.

### SUMMARY

The object of the invention is to make available an arrangement which permits communication among subscribers to a signal transmission system without additional control lines in a way which is as simple and cost-effective as possible.

In an arrangement with subscribers to a signal transmission system and a circuit for connecting bidirectional interfaces of subscribers to unidirectional interfaces of other subscribers, the circuit may comprise a first interface connection for connecting to a first bidirectional interface of a first subscriber and a second interface connection with two second connections, each for connecting to second unidirectional interfaces, specifically a reception connection for receiving received signals and a transmission connection for transmitting outgoing signals, wherein the first interface connection is connected to a first limiting voltage with intermediate arrangement of a fifth ohmic resistor, the circuit comprises a comparator with an inverting input, a non-inverting input and a comparator output, the first interface connection is connected to the non-inverting input of the comparator, the comparator is connected by its inverting input to a second reference voltage, the amplifier output is connected to a third reference voltage and the transmission connection with the intermediate connection of a third ohmic resistor, and the first interface connection is connected to the reception connection with the intermediate connection of a first resistor.

According to an embodiment, the first reference voltage and the third reference voltage can be at the same reference potential. According to an embodiment, the second reference voltage can be generated by means of voltage division between the reference potential and a ground potential or a band gap diode. According to an embodiment, the transmission connection and the reception connection can be each connected to a connection of a driver which amplifies signals. According to an embodiment, the driver may combine the signals on an individual signal line of bidirectional design. According to an embodiment, the first subscriber can be a tachograph, and a second subscriber can be a sensor which transfers, to the first subscriber, signals which are correlated with a vehicle velocity. According to an embodiment, a diode can be arranged between the first interface connection and the transmission connection, upstream or downstream of the first resistor.

### BRIEF DESCRIPTION OF THE DRAWINGS

The invention is described in more detail below by means of exemplary embodiments and with reference to drawings for clarification, in which drawings:

FIG. 1 is a schematic illustration of an arrangement which is simplified to what is significant,

FIG. 2 is a schematic illustration of an arrangement including two intermediately arranged driver components, and

FIG. 3 shows the voltage levels which arise at the first interface connection in the arrangement according to FIG. 1 within the scope of a signal transmission.

### DETAILED DESCRIPTION

The decisive advantage of the arrangement is the ability to detect automatically, by means of the circuit assigned to a party to a communication, whether the detected voltage levels are signals to be transmitted or signals to be received. According to an embodiment, it is possible for subscribers to a signal transmission system which are equipped with interfaces with different physical properties, in particular with interfaces which differ in terms of their directionality or which have to be operated with different voltage levels, to be connected to one another.

A different embodiment is the connection of, for example, two unidirectional interface pairs to one another, it being possible for said pairs also to have different physical properties, in which case one or both parties to the communication can each be assigned a circuit according to the invention so that only one signal line is necessary between the two parties without collisions of signal streams or even signal losses occurring.

The interface connections according to an embodiment can be, for example, completely normal plug type connections for forming electrically conductive connections. The individual reference voltages by means of which the signal levels are adapted to the signal levels carried by the interfaces can either be tapped at a suitable location in an electric circuit which is, if appropriate, located in the surroundings, or are generated by means of suitable dimensioning of the various ohmic resistors and connection to a voltage source. According to an embodiment, it may also be particularly advantageous to use a band gap diode to generate the desired respective voltage potential. It may be expedient if the first reference voltage and third reference voltage are at the same reference potential. An order of magnitude which is suitable in practice for the reference potential can be 5 volt. The second reference voltage can expediently be generated by means of voltage division between the reference potential and a ground potential or by means of a band gap diode. The second reference voltage may be advantageously less than 1 volt here so that the first bidirectional interface detects this reference potential as a LOW voltage potential when there is, for example, a LOW active logic.

In order to cover further signal transmission paths, it may be appropriate if the transmission connection and the reception connection of the circuit are each connected to a connection of a driver which amplifies signals. This driver can be designed with the advantage of eliminating one line in such a way that the signals are combined onto an individual signal line which is of bidirectional design. However, this may require corresponding transmission protocols to be implemented in the working algorithm of the microcontrollers which are located at the respective ends of the signal transmission system.

According to an embodiment, the first subscriber may be a tachograph and a second subscriber may be a sensor which transfers, to the first subscriber, signals which are correlated with a vehicle velocity. This may be particularly advantageous here because the relevant standards define the physical properties of the interfaces of the sensor and of the tachograph in different ways.

In particular, when there is a reception driver which is assigned to the first subscriber and which also drives the high level active in the environment of a LOW active logic, it can be particularly expedient to arrange a diode in the reception line of the circuit according to an embodiment so that if the first subscriber is transmitting, the driver which is assigned to the first subscriber does not increase the potential of the first interface connection at the bidirectional interface of the first subscriber by means of the reception line which is connected to the driver.

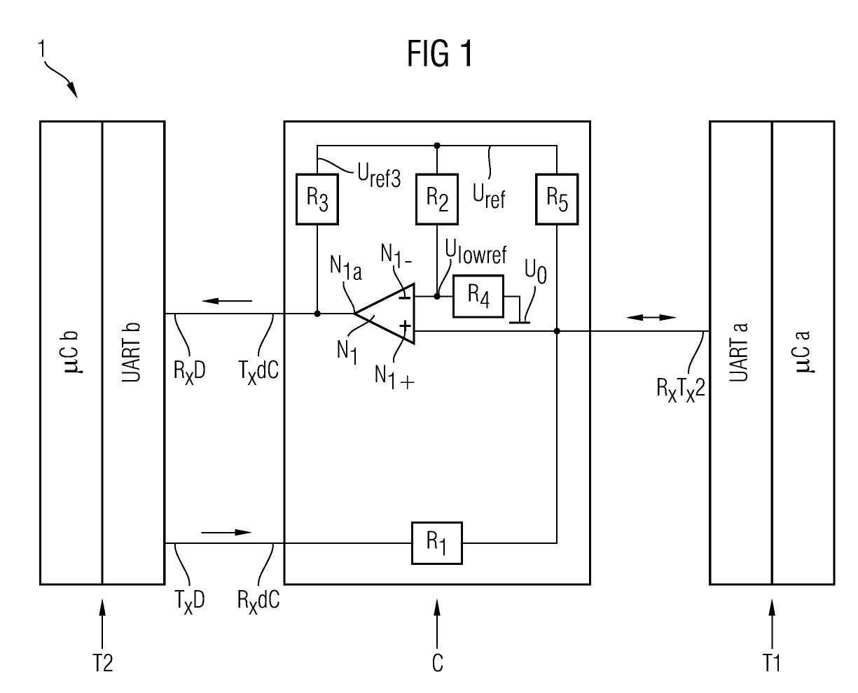

FIG. 1 shows the basic design of significant components of an arrangement 1 according to an embodiment, comprising a first subscriber T1, a circuit C and a second subscriber T2. The first and second subscribers T1, T2 each have a microcontroller μCa, μCb and an interface UARTa, UARTb (UART=Universal Asynchronous Receiver Transmitter) which is connected to the latter.

Here, the first interface UARTa is of bidirectional design with a first interface connection RxTx2 for transmitting and receiving.

The second interface UARTb has two second interface connections, specifically one reception connection RxdC and one transmission connection TxdC. Both the reception connection RxdC and the transmission connection TxdC are of unidirectional design.

Between the first subscriber T1 and the second subscriber T2 there is the circuit C according to an embodiment which, by means of a first interface connection RxTx2, has a bidirectional signal transmitting connection to the first subscriber T1 and is connected, by means of the transmission connection TxdC and the reception connection RxdC, to an interface reception connection RxD and an interface transmission connection TxD of the second subscriber T2, with unidirectional connections in each case. The central element of the circuit C is a comparator N1 to whose inverting input N1− a reference voltage Ulow-Ref is connected. Depending on the voltage connected to the non-inverting input N1+, the comparator N1 generates, as a function of the ohmic resistor R3, an output voltage which corresponds to the physical properties of the second interface UARTb and the signal to be transmitted by the subscriber T1, at its output N1a which is embodied as an open collector.

The reference voltage ULOWRef which is connected to the inverting input N1− of the comparator N1 is generated here by means of voltage division with the connection of a second resistor R2 and of a fourth resistor R4 between the reference voltage Uref and a ground potential U0.

A fifth ohmic resistor R5 is connected between the reference voltage Uref and the first interface connection RxTx2, said ohmic resistor R5 carrying out the function of a pull-up resistor for the bidirectional line of the first interface connection RxTx2.

If the generator T1 generates the voltage state HIGH of, for example, 5 volt at the first interface connection RxTx2 by means of the first interface UARTa, the comparator N1 outputs, at the transmission connection TxdC, a voltage of, for example, 5 volt corresponding to the HIGH level of the subscriber T2.

If the first subscriber T1 is transmitting LOW, a voltage of 0 volt is present, for example, at the first interface connection RxTx2, and the comparator N1 outputs a voltage of approximately 0 volt at the transmission connection TxdC, the reception connection RxdC of the second subscriber T2 recognizing said voltage as LOW.

In the arrangement of the exemplary embodiment as a LOW active logic, the voltage drops to approximately 0 volt at the reception connection RxdC if the second subscriber T2 is transmitting at its interface connection Txd by means of the connected reception connection RxdC of the circuit C, a voltage drop of approximately 1 volt occurring at a first ohmic resistor R1. Here, the first bidirectional interface connection RxTx2 has a voltage of approximately 1 volt since the fifth ohmic resistor R5 is correspondingly dimensioned and has the function of a pull-up resistor on the basis of the reference voltage Uref. The first interface UARTa tolerates here the voltage of approximately 1 volt which occurs as a LOW level so that it is detected as a signal transmitted by the second subscriber T2.

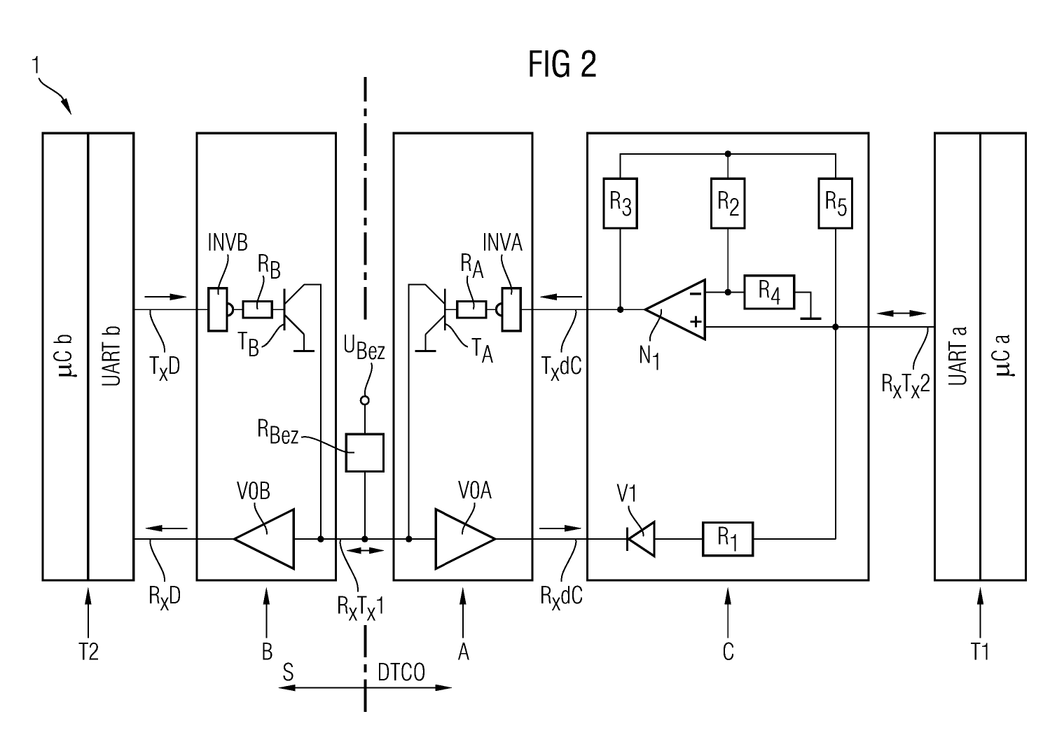

In a further embodiment, FIG. 2 shows an arrangement comprising two drivers A, B which are each assigned to a driver T1, T2. The illustration shows schematically from left to right components of the arrangement 1 according to an embodiment which are assigned to a sensor S by means of the elements T2 and B, and components of the arrangement 1 according to an embodiment which are assigned to a digital tachograph DTCO by means of the elements A, C and T1.

The logic is embodied as LOW active, the first subscriber T1 detecting voltage levels between 0 volt and 1.5 volt as LOW and voltages between 4.5 and 5.5 volt as HIGH. The second subscriber T2 has a corresponding detection characteristic and both subscribers transmit LOW signals at approximately 0 volt. The transmitted HIGH state is approximately 5 volt in both subscribers T1, T2.

The subscribers A, B are components according to relevant ISO Standards and each have an amplifier V0A, V0B, a transistor TA, TB, a basic resistor RA, RB, and an inverter INVA, INVB. Between the two drivers A, B there is a bidirectional signal line RxTx1 which is kept at a specific reference voltage level by means of a reference resistor RBEZ and a reference voltage UBEZ as a function of the transmission or reception state. The two drivers A, B switch the voltage of the bidirectional signal line RxTx1 to and fro between a LOW and a HIGH state as a function of the voltage levels applied by the subscribers T1 and T2, the drivers T1 and T2 exchanging signals with one another here on the basis of a specific protocol which either prevents collisions or, in the case of collisions which have not been prevented, provides for the signal transmission to be repeated. Accordingly, the drivers A and B are matched in their behavior to the protocol used for the signal transmission. In this regard, the bidirectional signal line RxTx1 simply has restricted bidirectionality since it changes in the direction of unidirectionality under the coordination of the protocol.

The method of operation of the circuit C according to an embodiment in FIG. 2 corresponds to that of the circuit C illustrated in FIG. 1, a diode V1 with a forward direction which is opposed to the direction of the signals of the reception connection RxdC being arranged between the reception connection RxdC and the first resistor R1. The forward direction of the diode is such that it has a LOW active logic. The diode V1 has a voltage drop of approximately 0.5 volt so that the resistor R1 should be given such small dimensions that a voltage of approximately 1 volt occurs at the first interface connection RxTx2 when there is a LOW signal of the second subscriber T2, said voltage being tolerated by the first subscriber T1 as a LOW signal. The resistors R2 and R4 which are arranged as voltage dividers define, at the comparator N1, the threshold for the LOW level within which the differentiation between transmission and reception is made with respect to the first interface UARTa. This can be, for example, 0.5 volt.

If the first subscriber T1 is transmitting, the voltage drops to 0 volt at the first interface UARTa or at the first interface connection RxTx2 so that 0 volt also occurs at the output of the comparator N1a. In this case, the inverter INVA ensures, via the basic resistor RA one line of the transistor TA which lowers the voltage level of the signal line RxTx1 to approximately 0 volt. Accordingly, the interface reception connection Rxd detects the voltage level LOW.

If the second transmitter T2 is transmitting, the voltage drops to 1 volt at the first interface UARTa or at the first interface connection RxTx2 so that 5 volt occurs at the output of the comparator N1a on the signal line RxTx1. In this case, the inverter INVA ensures, via the basic resistor RA, that there is a voltage of 0 volt at the base of the transistor TA. The interface connection RxTx2 tolerates the voltage of 1 volt as LOW.

If none of the subscribers T1 or T2 is transmitting, there is a resulting voltage of 8 volt in the signal line RxTx1 owing to the gain characteristic of the amplifiers V0A, V0B. At the first interface connection RxTx2 and the reception connection RxdC there is, respectively, 5 volt which both subscribers T1, T2 detect as a HIGH state.

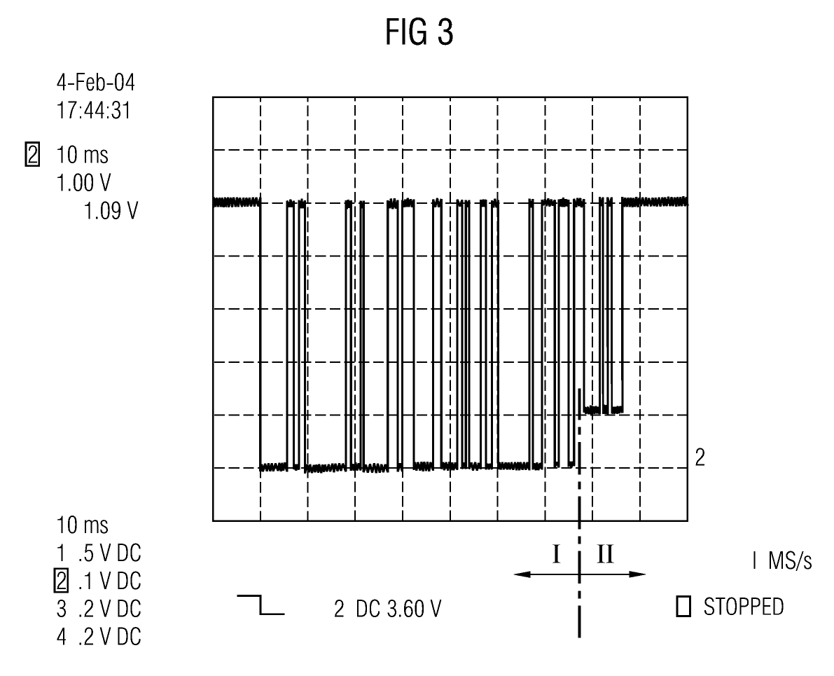

FIG. 3 shows the voltage profile at the first interface connection TxTx2 during a bidirectional signal transmission there. During a time period referred to by I the subscriber T1 transmits a number of low signals and then, during a time period referred to by II, the subscriber 2 turns LOW signals which, in contrast to the LOW signals of the zone designated by I, are not 0 volt but rather approximately 1 volt.

What is claimed is:

1. An arrangement with subscribers to a signal transmission system and a circuit for connecting bidirectional interfaces of subscribers to unidirectional interfaces of other subscribers, the circuit comprising:
a first interface connection for connecting to a first bidirectional of a first subscriber and
a second interface connection with two second connections, each for connecting to second unidirectional interfaces, specifically a reception connection for receiving received signals and a transmission connection for transmitting outgoing signals,
wherein
the first interface connection is connected to a first limiting voltage with intermediate arrangement of a fifth ohmic resistor,
the circuit comprises a comparator with an inverting input, a non-inverting input and a comparator output,
the first interface connection is connected to the non-inverting input of the comparator,
the comparator is connected by its inverting input to a second reference voltage,
the amplifier output is connected to a third reference voltage and the transmission connection with the intermediate connection of a third ohmic resistor, and
- the first interface connection is connected to the reception connection with the intermediate connection of a first resistor.

2. The arrangement according to claim 1, wherein the first reference voltage and the third reference voltage are at the same reference potential.

3. The arrangement according to claim 2, wherein the second reference voltage is generated by means of voltage division between the reference potential and a ground potential or a band gap diode.

4. The arrangement according to claim 1, wherein the transmission connection and the reception connection are each connected to a connection of a driver which amplifies signals.

5. The arrangement according to claim 4, wherein the driver combines the signals on an individual signal line of bidirectional design.

6. The arrangement according to claim 1, wherein the first subscriber is a tachograph, and a second subscriber is a sensor which transfers, to the first subscriber, signals which are correlated with a vehicle velocity.

7. The arrangement according to claim 1, wherein a diode is arranged between the first interface connection and the transmission connection, upstream or downstream of the first resistor.

8. A method for operating an arrangement with subscribers to a signal transmission system and a circuit for connecting bidirectional interfaces of subscribers to unidirectional interfaces of other subscribers, the method comprising:
connecting a first subscriber via a first interface connection to a first bidirectional interface,
establishing a second interface connection with two second connections, each for connecting to second unidirectional interfaces, specifically a reception connection for receiving received signals and a transmission connection for transmitting outgoing signals,
connecting the first interface connection to a first limiting voltage with intermediate arrangement of a fifth ohmic resistor,
connecting the first interface connection to a non-inverting input of a comparator,
connecting the comparator by its inverting input to a second reference voltage,
connecting the amplifier output to a third reference voltage and the transmission connection with the intermediate connection of a third ohmic resistor, and
connecting the first interface connection to the reception connection with the intermediate connection of a first resistor.

9. The method according to claim 8, wherein the first reference voltage and the third reference voltage are at the same reference potential.

10. The method according to claim 9, comprising: generating the second reference voltage by means of voltage division between the reference potential and a ground potential or a band gap diode.

11. The method according to claim 8, comprising: connecting the transmission connection and the reception connection each to a connection of a driver which amplifies signals.

12. The method according to claim 11, comprising: combining the signals on an individual signal line of bidirectional design by the driver.

13. The method according to claim 8, wherein the first subscriber is a tachograph, and a second subscriber is a sensor which transfers, to the first subscriber, signals which are correlated with a vehicle velocity.

14. The method according to claim 8, wherein a diode is arranged between the first interface connection and the transmission connection, upstream or downstream of the first resistor.
